(19) United States
(12) Patent Application Publication
(10) Pub. No.: US 2011/0023014 A1
(43) Pub. Date: Jan. 27, 2011

(54) METHOD AND APPARATUS FOR MODIFYING AN EXECUTABLE APPLICATION USING IN-MEMORY OBJECT REPRESENTATION

(75) Inventors: Jeffrey Todd Harper, Tualatin, OR (US); Heston Hsin Sheng Chu, Portland, OR (US); Joseph Luigi DiMartino, Beaverton, OR (US)

Correspondence Address: MARGER JOHNSON & MCCOLLOM, P.C., 210 SW MORRISON STREET, SUITE 400, PORTLAND, OR, 97204, US

(73) Assignee: Ensequence, Inc., Portland, OR (US)

(21) Appl. No.: 12/509,328

(22) Filed: Jul. 24, 2009

(51) Int. Cl. G06F 9/44

(52) U.S. Cl. 717/108; 717/110; 717/116; 717/168

(57) ABSTRACT

A computer system is used to create an application. An executable application is converted into an in-memory object representation. The in-memory object representation may be annotated with human-readable labels. The in-memory object representation and human readable labels may be stored in a storage device. At least one attribute of the in-memory object representation is selected for modification. At least one modification is performed on the in-memory object representation of the application. The modified representation is used to create an executable application.

### FIELD OF THE INVENTION

This invention relates generally to modification of an application program to produce an upgraded version of the program. More specifically, the invention describes a system and method for creating a modified version of an executable application without the use of source code.

### BACKGROUND OF THE INVENTION

A common technique in software engineering is to start with the source code for an existing application when creating a new application. This is particularly useful when coding a user interface or similarly complex application, since an existing application can provide a functioning framework that can be incrementally modified to replace the old appearance and behavior with new appearance and behavior.

Application templates have been developed to serve this purpose. An application template is an example application framework intended to be modified and extended to implement an application of the general type and format of the template. Application templates are commonly provided as source code, and serve a purpose similar to document templates in a word processing application, or a presentation template in a presentation authoring application.

Sometimes a software application development environment (ADE) allows the creation of an application template from an existing application. Sometimes this involves nothing more than making a copy of the source code for the existing application in a special repository from which it may be copied when the template is employed in the ADE. In other cases, the source code may be re-encoded into a special form, or have additional metadata associated that defines the attributes of the template. U.S. Pat. No. 6,590,589 describes an example of one such ADE that incorporates sophisticated features for creating an application template and generating a custom application from the template. Template creation systems known in the prior art rely on the use of source code for the original application when creating the application template.

In many software systems, the requirement often arises to modify a deployed executable application. This need is so prevalent that special patching protocols and techniques have been developed to accomplish the modification of an existing executable application, shared executable library, or other executable element of a deployed software system. For example, the Windows™ operating system available from Microsoft Corp. includes an Automatic Updates™ feature that periodically searches for the existence of patches to operating system files and installed applications, and then downloads and applies the patches as available. The patch creation process commonly proceeds by modifying the source code for the executable element to be modified; generating a new version of the executable element from the modified source code; analyzing the difference between old and new versions of the executable element; and creating one or more patches that apply differencing operations to modify the old deployed executable element.

On occasion the need arises in software engineering to modify an executable application for which source code is not available. A common technique employed in such cases is to reverse-engineer or decompile the executable application to generate source code that is equivalent but not identical to the original source code from which the application was generated. For example, a Common Object File Format (COFF) file may be decompiled to generate an assembly language source file. The resulting assembly language source file could be passed through an assembler to generate a COFF file identical to the original. Once the assembly language source file is produced, the source code can be edited and modified as desired, with the effect that a new executable generated from the modified source code would carry the desired modifications in application appearance and behavior. As a further example, U.S. Pat. No. 6,026,237 describes methods of deconstructing a Java class file into the corresponding source code, modifying the source code, and reconstructing a modified Java class file. A difficulty presented by these reverse-engineering techniques is that the source code produced by the reverse-engineering process is often complex and arcane, requiring significant skill and effort to interpret. This is particularly true if the author of the application has employed obfuscation techniques known in the art to complicate or obviate the reverse-engineering process. Even when the generated source code is uncomplicated, modification of the source code requires engineering knowledge and experience with the source code language and with design and coding practices employed therewith.

What is required is a computer method for modifying an executable application that does not depend on access to the source code used to generate the executable application and does not depend on specialized engineering knowledge and experience in dealing with decompiled source code.

### SUMMARY OF THE INVENTION

The current invention provides a method for creating a modified version of an executable application characterized by processing an executable application to create an in-memory object representation of the application, selecting at least one attribute of the in-memory object representation for modification, modifying the at least one selected attribute of the in-memory object representation, and generating an executable application from the modified in-memory object representation.

In a further embodiment of the inventive method, the in-memory object representation is stored into and retrieved from persistent storage.

In a still further embodiment of the inventive method, the storing step includes serializing the object hierarchy into an Extended Markup Language (XML) file in persistent storage.

In a still further embodiment of the inventive method, the retrieving step includes de-serializing the XML file into an object hierarchy to re-create the in-memory object representation.

In a still further embodiment of the inventive method, an attribute of the in-memory object representation is annotated with a human-readable tag, and the human-readable tag is used when selecting an attribute of the in-memory object representation to be modified.

In a still further embodiment of the inventive method, one or more human-readable tags are stored into persistent storage and retrieved from persistent storage in association with the in-memory object representation.

In a still further embodiment of the inventive method, the selection of an attribute for modification is performed in part by interaction with a simulation of the executable application.

In a still further embodiment, the attribute of the in-memory object representation to be modified is one of the position, size, shape, or color of a region of color displayed by the application; one of the position, background color, font face, font size, font weight, text color, alignment, or textual content of an area of text displayed by the application; or one of the position, size, or image content of an image displayed by the application.

In a still further embodiment, the in-memory object representation of the executable application includes a set of object instances that form an object hierarchy.

In a still further embodiment, the executable application is an ETV-BIF executable application, and the inventive method further includes allowing selection of a first PageResource object instance of the ETV-BIF executable application, said first PageResource object having a heap with structures associated therewith; if the first PageResource is selected, allowing determination of a size and a sequential order of heap structures of the PageResource object; and computing all absolute and relative heap offsets contained in the heap structures and storing said offsets into respective heap structures.

The current apparatus also describes an apparatus configured to implement the invention. A computer system configured to create a modified version of an executable application includes a processor configured to create an in-memory object representation from an executable application. The computer system further includes a graphical user interface configured to allow selection of at least one attribute of said in-memory object representation for modification. The computer system further includes means for modifying said at least one attribute of said in-memory object representation and a program configured to generate an executable application from said modified in-memory object representation.

In a further embodiment of the computer system configured to implement the invention, the graphical user interface includes a plurality of panels displayed on a display, with each panel displaying various attributes of the executable application.

In a still further embodiment of the computer system configured to implement the invention, the graphical user interface includes at least one panel displaying an object instance hierarchy of the in-memory object representation, wherein each object of the instance hierarchy may be selected by a user of the computer system.

### BRIEF DESCRIPTION OF THE DRAWINGS

The preferred and alternative embodiments of the present invention are described in detail below with reference to the following drawings.

FIG. 1 depicts an exemplary system configured to practice the inventive method.

FIG. 2 depicts a flowchart of an exemplary implementation of the inventive method.

FIG. 3 depicts the graphical output of an example application.

FIG. 4 depicts the common resource format for ETV-BIF resources.

FIG. 5 depicts the structure of an exemplary in-memory object representation of the example application.

FIG. 6 depicts an exemplary flowchart of steps to generate an executable application from an in-memory object representation of the application.

FIG. 7 depicts a schematic representation of a portion of the user interface of an exemplary computer application configured to practice the inventive method.

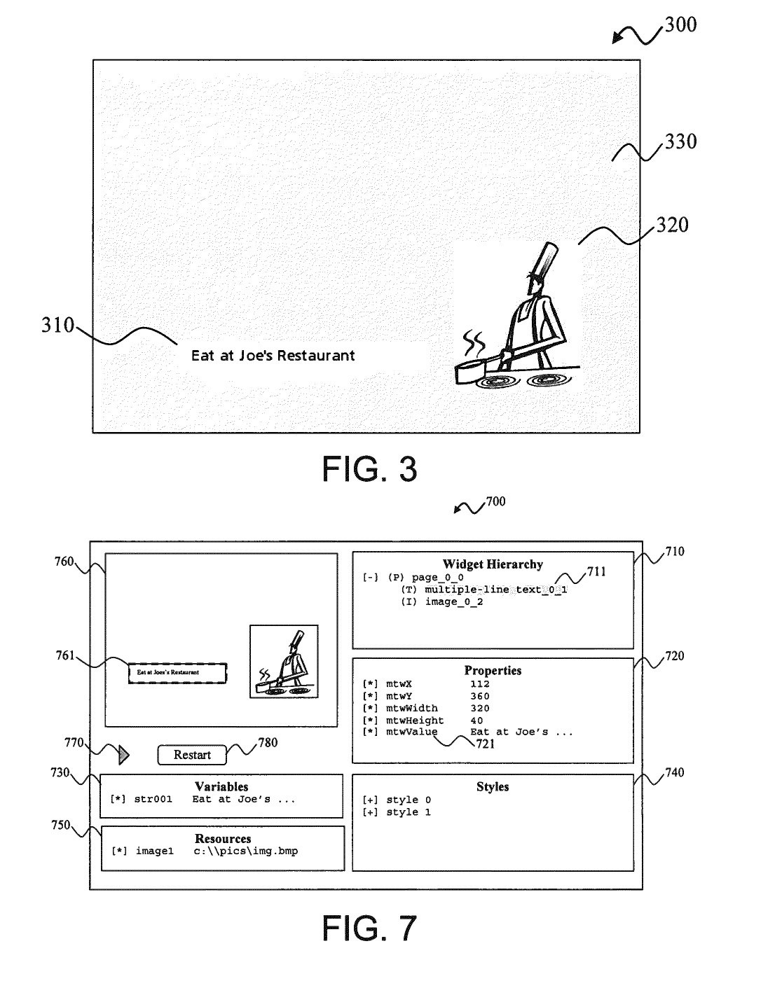

APPENDIX lists the content of the page resource for the application depicted in FIG. 3 shown in human-readable format.

### DETAILED DESCRIPTION OF THE INVENTION

By way of overview, embodiments of the present invention provide a method for authoring a modified version of an application.

As used herein, the term “application” is intended to refer generally to an experience of appearance and behavior engendered by a computing platform. An application is commonly authored in a source code language using an authoring environment, the source code being used to generate an executable version of the application for deployment to a computing platform to realize the desired experience.

As used herein, the term “executable application” is intended to refer to a body of digital information comprising executable instructions and data that when processed on a suitable computing platform yields appearance and behavior as intended by the creator of the application. An executable application may be encoded using native CPU instructions, interpreted byte codes, declarative data structures, or any combination of such encodings. An executable application may respond to external events by appropriate modification of appearance and behavior, as specified by the code and data comprising the executable application.

As used herein, the term “in-memory object representation” is intended to refer to a set of data stored in volatile or non-volatile read-write memory within a computer, the data characterizing the appearance and behavior of an application. The data comprises one or more object instances in a hierarchy, and may comprise one or more text strings, one or more binary data blocks, any combination thereof, or other suitable data configuration.

As used herein, the term “object” is intended to refer to a software entity defined by a body of software code that declares the member properties and functions of the entity. Objects form the basis of object-oriented software languages. An object may be considered to be a collection of data upon which operations can be performed, the object encapsulating the details of how the data are stored and manipulated.

As used herein, the term “object instance” is intended to refer to a collection of data in a structured format that describe a single instantiation of a software object class defined by member properties and functions. The data of an object instance correspond to the values of the various member properties of the class. The data of an object instance may include executable code in source or executable format corresponding to a property or properties of the instance. The complete representation of an object instance may also require reference to the values of properties shared by all instances of the software object class. In common with conventional usage, the term “object” may refer herein to a class of entities with a shared specification or to a specific instance of the class, depending on the context of the usage. When necessary to disambiguate the latter meaning, the term “object instance” is used in distinction to the term “object”.

As used herein, the term “object representation” is intended to refer to an object instance or a hierarchy of object instances, the cumulated properties of which and relationships among which represent the structure and functionality of an application. Each of the object instances in an object representation has associated properties and functions defined by the body of software code that declares the member properties and functions of the corresponding object class.

As used herein, the phrase “generate an application” is intended to refer to the process of converting an in-memory object representation of an application into a machine-readable format suitable for storage, retrieval and distribution that can be ingested and executed by a suitable computing platform.

As used herein, the term “resource” is intended to refer to a body of binary data that is used during the execution of an application to control the appearance or behavior of an application.

The various aspects of the claimed subject matter are now described with reference to the annexed drawings. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. Additionally it should be appreciated that a carrier wave can be employed to carry computer-readable electronic data such as those used in transmitting and receiving electronic mail or in accessing a network such as the Internet or a local area network. Of course, those skilled in the art will recognize many modifications may be made to this configuration without departing from the scope or spirit of the claimed subject matter.

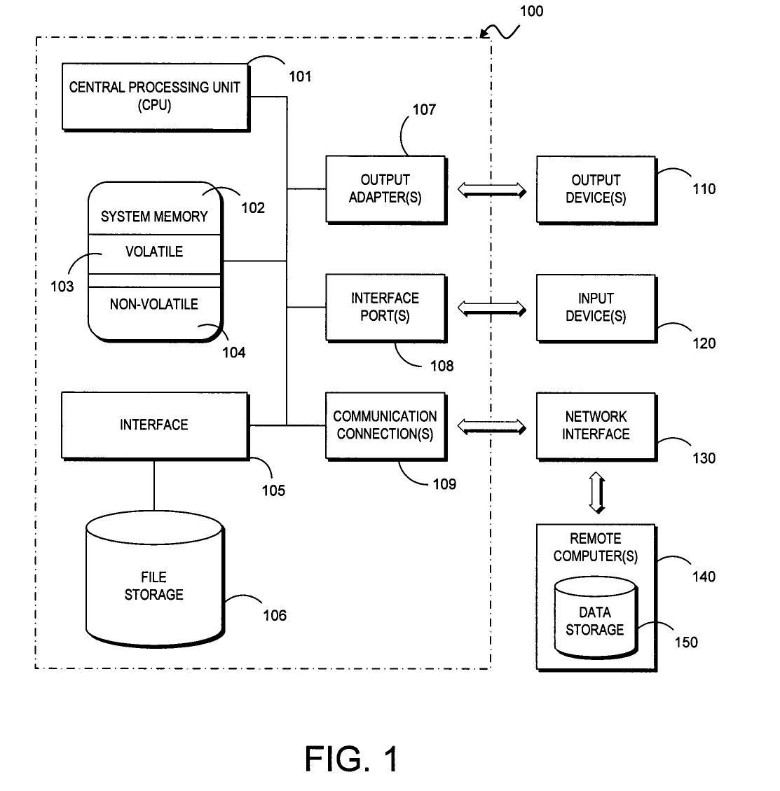

FIG. 1 shows the components of a workstation computer 100 that can be programmed or constructed to implement the steps of the inventive method. Central processing unit 101 executes instructions read from system memory 102. Software code and data may be stored in volatile memory 103 or non-volatile memory 104. Workstation computer 100 optionally includes an interface component 105 that reads and writes files from a file storage component 106. File storage component 106 may comprise a removable or non-removable storage element using magnetic, optical, opto-magnetic, resistive, or other non-volatile storage methodology. Workstation computer 100 includes output adapter(s) 107 that communicates with output device(s) 110, which may include a display terminal, audio speaker, printer, or other device. The communication between an output adapter 107 and an external output device 110 may be wired or wireless. Workstation computer 100 includes interface port(s) 108 that communicates with input device(s) 120, which may include a keyboard, mouse, pointing tablet, scanner, or other device. The communication between an input adapter 108 and an input device 120 may be wired or wireless. Workstation computer 100 may optionally include communication connection(s) 109 that communicates through a network interface 130 to remote computer(s) 140. The remote computer may include data storage 150 which may comprise non-volatile memory, disk storage, or other persistent storage system.

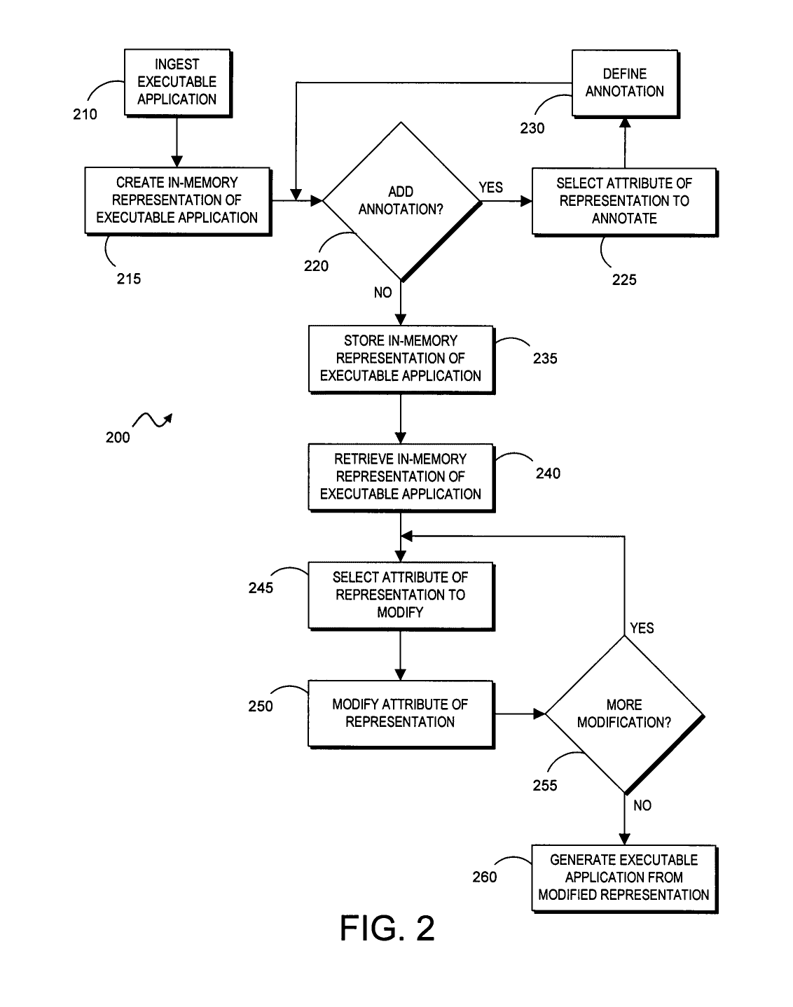

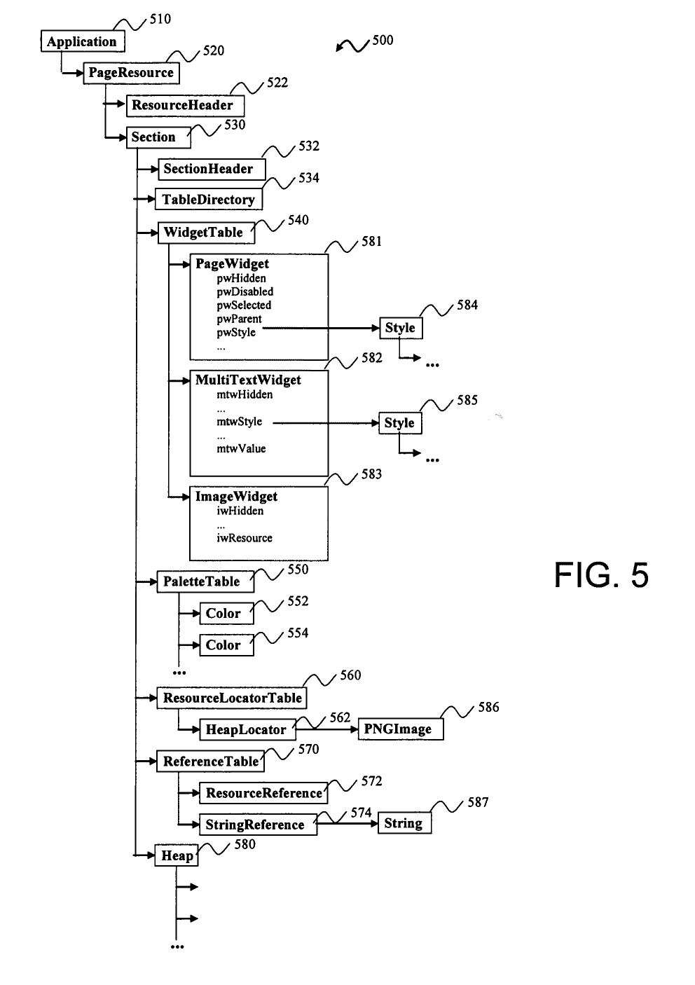

Attention is now directed to FIG. 2, which depicts a flowchart 200 of the steps of an exemplary implementation of the inventive method. In a preferred embodiment of the inventive method, the steps of flowchart 200 are practiced by one or more users of a computer system, of which FIG. 1 depicts an exemplary example. The actions described in the steps of flowchart 200 are preferentially performed by or through the use of a software application executing on the computer system and encoded to perform each of the operations described below, the operations being performed either automatically or under user control through an interactive interface. At a step 210, a user selects an executable application to be ingested by the computer system. The executable application may be acquired through a network connection, from a portable storage device, from a storage device attached to the computer, or through other means known in the art. The executable application may be in the form of one or more binary files in a known format. At a further step 215, an in-memory object representation of the executable application is created, a structural example of which is illustrated in FIG. 5. At a further step 220, a user makes a decision to add annotation to the in-memory object representation. If a user decides to add annotation to the in-memory object representation, at a further step 225 a user selects an attribute of the in-memory object representation to annotate. At a further step 230, a user defines annotation for the selected attribute. After executing step 230, step 220 is repeated. When all desired annotation has been defined, at a further optional step 235 the in-memory object representation is stored, along with any defined annotation, into persistent storage. In a preferred embodiment, the in-memory object representation of the executable application is a set of object instances that form an object hierarchy, and storage of the in-memory object representation is achieved by serializing the object hierarchy into an Extended Markup Language (XML) file in persistent storage. If the in-memory object representation has been stored in persistent storage, at a further optional step 240 the in-memory object representation is retrieved, along with any defined annotation, from persistent storage. In a preferred embodiment, the retrieval is achieved by de-serializing an XML file into an object hierarchy to re-create the in-memory object representation.

At a further step 245, a user selects an attribute of the in-memory object representation to modify. At a further step 250, a user modifies the attribute of the in-memory object representation. At a further step 255, a user makes a decision to perform more modification. If a user decides to perform a further modification, step 245 is repeated. If a user decides not to perform a further modification, at a further step 260 an executable application is generated from the modified in-memory object representation.

The steps of flow chart 200 may be performed by a single user or by multiple users working consecutively or concurrently.

To further clarify the inventive method, the following discussion will consider an exemplary implementation of the inventive method in which the executable application takes the form of one or more Enhanced Television-Binary Interchange Format (ETV-BIF) modules. The ETV-BIF binary format and the behavioral requirements for a compliant ETV-BIF user agent are defined by OpenCable specification OC-SP-ETV-BIF1.0-I04-070921 “Enhanced TV Binary Interchange Format 1.0” issued by Cable Television Laboratories Inc., Louisville, Colo., incorporated herein by reference.

Briefly, an ETV-BIF executable application consists of one or more resource modules that are broadcast to a receiver executing a user agent application. The resource modules are received and interpreted by the user agent application to create the appearance and behavior of the ETV-BIF executable application. An ETV-BIF executable application includes at least one page resource module. A page resource module contains a series of tables that define an object hierarchy constructed from the various native objects (“widgets”) defined by the ETV-BIF standard; color data used when displaying graphical content on the television screen attached to the receiver; optional references and optional variables that contain static or dynamic values used during the execution of the application to control application appearance or behavior; optional event function code that is executed in response to events; optional locators to locate broadcast modules or external resources for use by the application; and optional data used to control application appearance and behavior. An ETV-BIF executable application may also include one or more data resource modules, each of which contains one or more data tables used by the application. In addition, image or font resource modules may be broadcast for use by an execution application. Additional signal and trigger data may be broadcast to the user agent during execution to control user agent and application behavior. Data, image and font resources may be updated in the broadcast stream during the execution of an application.

By way of illustration, FIG. 3 depicts the graphical presentation 300 of an example ETV-BIF application. The executable content of this application comprises a single page resource module. When the application is recognized in the broadcast stream and the signal data indicates that the application should execute, the user agent downloads the page resource module and processes the content according to the ETV-BIF specification. The application displays a text slogan 310 and an image icon 320. The graphical background 330 may be filled with a solid or semi-transparent color, or may be transparent to allow the underlying video to display. After a fixed period of time, the application terminates and the graphical display is cleared.

An author may wish to modify the appearance of the example application, for example by modifying the position, size, shape, or color of the region of color displayed behind the slogan 310; the position, background color, font face, font size, font weight, text color, alignment, or textual content of slogan text; or the position, size, or image content of the image icon 320.

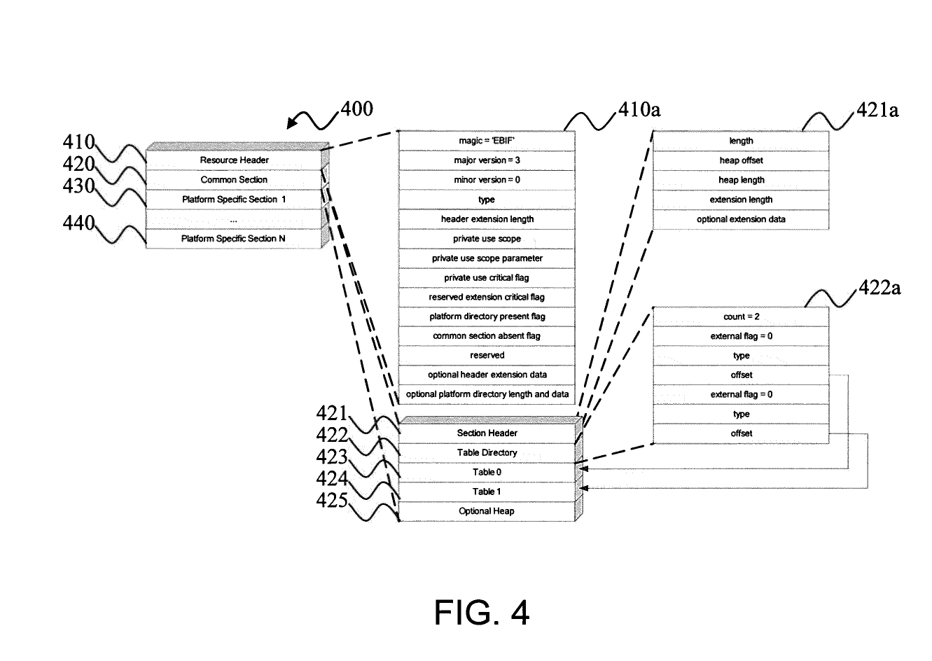

FIG. 4 shows the common resource format illustration from the ETV-BIF specification. As depicted, a resource 400 consists of a resource header 410 and one or more sections 420, 430, 440. A section 420 comprises a section header 421, a table directory 422, one or more tables 423, 424, and an optional heap 425. The formats of all of the elements in an ETV-BIF binary resource are defined in the ETV-BIF specification. For example, the contents of resource header 410a are defined in Section 8.1, the contents of section header 421a defined in Section 8.2, the contents of table directory 422a defined in Section 8.3, and the format of tables 423, 424 is defined in Section 8.4.

The content of the page resource for the application depicted in FIG. 3 is shown in a human-readable listing in the APPENDIX. As the listing demonstrates, the page resource, in conformance with the ETV-BIF specification, comprises a resource header, a section header, a table directory, a series of tables, and a heap. Many table cells refer to data contained in the heap. For clarity in the following discussion, the listing depicts the contents of certain structures contained in the heap in the context in which the structures are referenced.

The first table in the page resource (labeled “Table 0x0000” in the APPENDIX) is a widget table that contains references to three widget structures contained in the heap. The first widget is the single Page widget for the application. The widget structure referenced in the heap (in this case, at heap offset 0x24) defines the initial values for the properties of the Page widget, corresponding to the ebiPageWidget( ) structure defined in Section 10.9 of the ETV-BIF specification. For example, the width of the page is 704 pixels, the page identifier is 1, and the timeout period is 5000 milliseconds. The second widget in the table is a Multiple-Line Text widget, which has an associated widget structure at heap offset 0x11, corresponding to the ebiMultipleLineTextWidget( ) structure defined in Section 10.8 of the ETV-BIF specification. The third widget in the table is an Image widget, which has an associated widget structure at heap offset 0x1, corresponding to the ebiImageWidget( ) structure defined in Section 10.7 of the ETV-BIF specification. Note that the widgets are assigned arbitrary names in the listing, so that the parent widget of the third widget (image_{—}0_{—}2) is indicated as page_{—}0_{—}0.

The second table in the page resource is a palette table that lists the 16 colors that can be used in this application. The format for a palette table is defined in Section 9.4 of the ETV-BIF specification. The third table is a resource locator table, the format of which is defined in Section 9.7 of the ETV-BIF specification. The resource locator table contains a single entry, which points to an image resource stored in the heap at offset 0x106. This resource is encoded using the Portable Network Graphics (PNG) encoding standard.

The fourth table in the page resource is a reference table, the format of which is defined in Section 9.7 of the ETV-BIF specification. The reference table contains two entries, one that references the resource locator for the image resource, and one that references the slogan string “Eat at Joe's Restaurant” which is stored in the heap at offset 0xed.

The two styles shown in the listing are each stored as a set of structures in the heap at the indicated offsets. The formats of the various style-related structures are defined in Section 11 and its subsections in the ETV-BIF specification. The final portion of the listing is a hexadecimal and ASCII display of the contents of the heap.

In this exemplary implementation of the inventive method, an executable application encoded using the ETV-BIF binary standard is converted into an in-memory object representation that consists of a series of objects corresponding to the widgets, structures, and other data constructs that comprise ETV-BIF page and data resources. Each object reflects the corresponding elements of the ETV-BIF binary format. The top-level object represents the application as a whole, and contains a list of pointers to the resources, signals, and triggers that define the application. In this object representation, each resource is represented by an object corresponding to the content of the resource. For example, a page resource is represented by a PageResource object that points to a ResourceHeader object and a list of Section objects. Similarly, a data resource is represented by a DataResource object with the same basic structure. This parallels the structure for an ETV-BIF resource shown in FIG. 4. A Section object points to a SectionHeader object, a TableDirectory object, and a list of Table objects. Again, this parallels the structure for an ETV-BIF resource section shown in FIG. 4. A Table object is a generic object representing a generic table and pointing to a TableHeader object. The generic Table object has derived object classes that represent each specific type of table, including a MetadataTable object, a WidgetTable object, a PaletteTable object, and so forth. Each ETV-BIF widget type has a corresponding object class. Other object classes represent the other structures that can occur in an ETV-BIF binary resource, including for example Style, BackgroundStyle, NavigationMap, NavigationMapItem, and so forth.

Many objects used in an in-memory object representation have object properties that record information from the ETV-BIF binary content. For example, a ResourceHeader object has properties that reflect the fields defined in the ebiResourceHeader( ) structure defined by the ETV-BIF specification.

The data in image and font resources are encoded in standardized formats. Image and font resources are represented in the in-memory object representation as blocks of binary data that are passed unmodified from the original executable application representation to the modified executable application representation.

FIG. 5 depicts a portion of an exemplary object instance hierarchy 500 comprising an in-memory object representation of the application depicted in FIG. 3. Application object instance 510 is the root of the object hierarchy. Application object instance 510 contains a pointer to a PageResource object instance 520. PageResource object instance 520 contains pointers to a ResourceHeader object instance 522 and a Section object instance 530. Section object instance 530 contains pointers to a SectionHeader object instance 532, a TableDirectory object instance 534, object instances 540, 550, 560, 570 corresponding to the tables in the section, and a Heap object instance 580.

WidgetTable object instance 540 contains a list of pointers to the widgets referenced in the table. A widget is encoded in the binary by a structure in the heap. In FIG. 5, PageWidget instance 581 represents a structure in the heap encoding the contents of the ebiPageWidget( ) structure defined by the ETV-BIF specification. One property of the PageWidget object instance 581 is a pointer to a Style object instance 584, which corresponds to an ebiStyle( ) structure. A Style object instance may also point to subordinate style object instances (not shown) representing the sub-structures that define an ETV-BIF style. Other widget instances from the ETV-BIF page resource are represented by MultiTextWidget object instance 582 and ImageWidget object instance 583. MultiTextWidget object instance 582 contains a pointer to a Style object instance 585.

PaletteTable instance 550 contains a list of pointers to Color objects that correspond to the colors defined in the table. ResourceLocatorTable object instance 560 contains a pointer to a HeapLocator object instance 562; the HeapLocator object instance 562 contains a pointer to a PNGImage object instance 586, the data for which are contained in the heap. ReferenceTable instance 570 contains a list of pointers to a set of Reference object instances: ResourceReference object instance 572 contains a reference to the first entry in the ResourceLocatorTable object instance 560, while StringReference object instance 574 contains a pointer to a String object instance 587. String object instance 587 contains the literal text of the string “Eat at Joe's Restaurant”.

Heap object instance 580 contains a list of pointers to object instances 581, 582, 583, 584, 585, 586, 587 that correspond to structures stored on the heap. This list is generated as the heap is decompiled from references to heap contents contained in other structures in a binary resource. For example, the widget table in an ETV-BIF page resource contains a set of heap offsets; each heap offset points to a self-identifying structure that corresponds to one of the defined widget structures (or a structure representing an extension widget). For each widget structure in the heap, there is a corresponding object instance in the in-memory object representation. A widget structure may include one or more fields that refer to other structures on the heap; for example, an ebiPageWidget( ) structure contains a pwStyle field that references an ebiStyle structure on the heap. By reading and decoding the contents of the various tables and structures in an ETV-BIF page or data resource, the various heap contents can be identified and represented by appropriate object instances.

Each list contained in an object instance in this exemplary in-memory object representation is maintained in sequential order of the corresponding contents of the ETV-BIF resource being represented. By this means, the contents of the ETV-BIF resource can be reconstructed from the in-memory object hierarchy, since all of the structure and content of the ETV-BIF resource is represented in the in-memory object hierarchy. Modifications to attributes of the object hierarchy may result in corresponding changes to the modified executable application generated from the object hierarchy, as described below.

An ETV-BIF page resource may contain other table types in addition to those discussed above, including for example an action table and a metadata table. The properties of these other table types, and other structures not discussed above, will be evident to one skilled in the art from an analysis of the listing in the APPENDIX, the ETV-BIF binary standard, and the contents of FIG. 3 and FIG. 5 in the light of the foregoing discussion. An ETV-BIF data resource may contain only a subset of the table types allowable in a page resource, and an ETV-BIF data resource is represented in the in-memory object representation by a DataResource object instance that can reference the appropriate subset of Table object types is otherwise similar to the PageResource object described above. Image and font resources are represented in the in-memory object representation by generic Resource object instances, the contents of which reflect the binary content of the corresponding resource file. Image and font resources are copied without modification into the generated executable output.

The foregoing description with regard to an in-memory object representation of an ETV-BIF executable application is intended to be exemplary and not limiting as to the scope and spirit of the inventive method. One skilled in the art will recognize that other object classes or data structures could be employed in distinction to the object classes described above when constructing an in-memory object representation of an ETV-BIF executable application without departing from the spirit of the inventive method.

To further illustrate the inventive method, the reader's attention is again directed to FIG. 2 in the light of the foregoing description of FIG. 3 and FIG. 5. In an exemplary implementation of the inventive method, the ETV-BIF page resource representing the application depicted in FIG. 3 is read at a step 210. At a further step 215, an in-memory object representation of the page resource is created in the form of an object hierarchy 500 depicted in part in FIG. 5. At a further step 220, a user may select an attribute to modify, for example the name given to the MultiTextWidget object instance 582. As described above, when the in-memory object hierarchy is created, each widget representation is given an arbitrary name, in this case “multiple-line text_{—}0_{—}1”. A user may select this attribute at a step 225, and at a further step 230, may specify for example that the widget represented by MultiTextWidget object instance 582 have the name “slogan_widget”. A user may select an additional attribute to annotate, for example the mtwValue property of the MultiTextWidget object instance 582, and assign to the property the name “slogan-text”. Other attributes of the in-memory object representation may be annotated by this means. Preferentially the annotations are stored in the corresponding object instances as further properties. In an alternative embodiment, the annotations may be stored in a suitable form distinct from the object instances for presentation in the user interface in further steps.

When all annotations have been defined, at a further step 235 the in-memory object representation of the executable application may optionally be stored in persistent storage. In this exemplary implementation, the storage may be performed by serializing the contents of the Application object instance 510 and, recursively, all the objects instances to which Application object instance 510 points, storing the serialized content into a file. In an alternative embodiment, the in-memory object representation could optionally be stored into a relational database.

At a further step 240 the in-memory object representation of the executable may optionally be retrieved from persistent storage. In this exemplary implementation, the retrieval could be performed by de-serializing the contents of a file to create the Application object instance 510 and, recursively, all the object instances to which Application object instance 510 refers. In an alternative embodiment, the in-memory object representation could be retrieved from a relational database.

At a further step 245, a user selects an attribute of the in-memory object representation to modify. As an example, a user may select the mtwX property of the MultiTextWidget object instance 582. At a further step 250, a user specifies the new value for the attribute. By specifying a value other than the initial value (112, as shown in the listing in the APPENDIX) of the mtwX property of the MultiTextWidget object instance 582, a user would cause the display of the text region 310 to be shifted horizontally on the display when the application executes. At a further step 255, a user may elect to make more modifications. Preferentially the interface through which the selection of an attribute is made will employ any annotations specified in step 230. For example, again at a step 245 a user may select the value of the mtwValue property of the MultiTextWidget object instance 582 to modify, where the user interface displays the label “slogan-text” for this property. At a step 250 a user specifies a new slogan string, for example, “Buy your gas at Manny's”. The new slogan string would replace the original value in String object instance 587. A user may repeat steps 245 and 250 to modify additional attributes of the in-memory object representation of the application, such as the mtwWidth property of MultiTextWidget object instance 582, or the content of PNGImage object instance 586. A user may also select a Resource object instance for modification, in which case the modification would entail replacement of the binary content of the Resource object instance with new content.

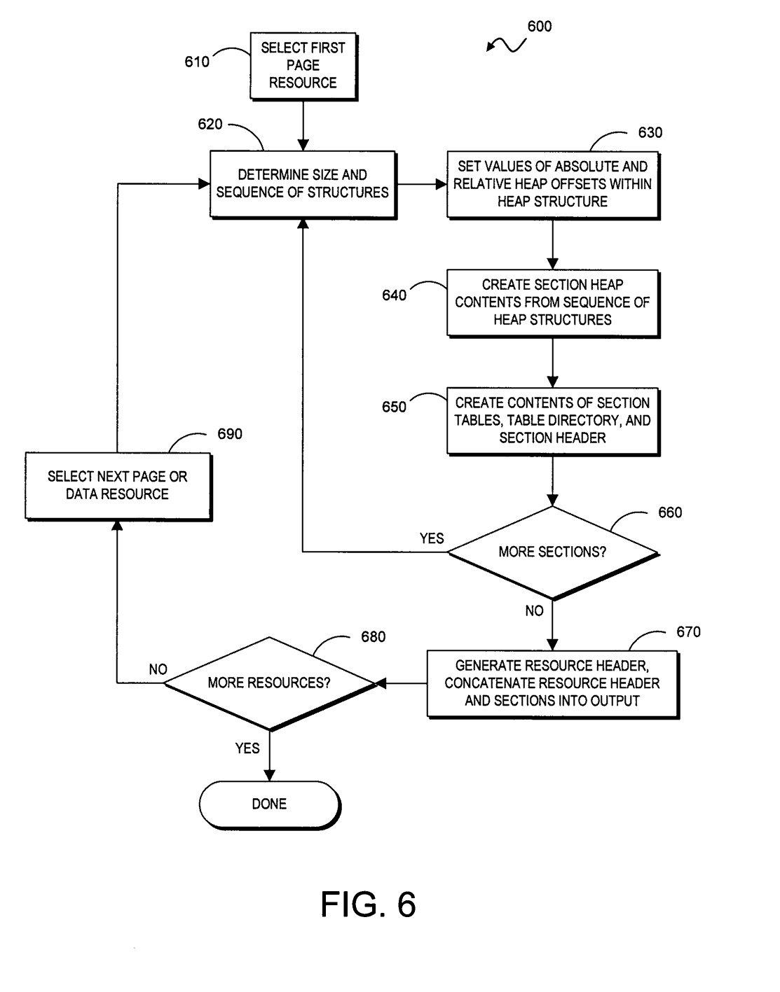

Once all modification have been made to the in-memory object representation, at a further step 260 an executable application is generated from the modified in-memory object representation. In an exemplary implementation, the Application object instance hierarchy is used to generate the corresponding ETV-BIF page and data resources representing the executable application. Preferentially this process proceeds by the steps of the flowchart 600 depicted in FIG. 6. At a step 610, the first PageResource object instance is selected. An ETV-BIF executable application will always include at least one page resource, so the in-memory object representation will always have at least one PageResource object instance as a child of the Application object instance. At a further step 620, the size and sequential order of the structures comprising the heap of the first section of the selected resource are determined. Each structure will have a fixed size, although the contents of all structures cannot necessarily be determined at this point. At a further step 630 the values of all absolute and relative heap offsets contained in heap structures are computed and stored into the respective heap structures. At a further step 640 the contents of the heap are created by concatenation of the contents of all the structures in the heap. After step 640 the size and content of the heap, and the offset of every structure in the heap, are known and fixed. At a further step 650 the contents of all tables in the section, the table directory for the section, and the header for the section are created from the corresponding object instances in the in-memory object representation. Where appropriate, heap offsets are stored into tables as the tables are created, according to the known content of the section heap.

Once the tables, table directory, and section header contents are known, the elements of the section are concatenated in the appropriate order to create the section content. At a further step 660, if more sections are present in the selected resource, step 620 is repeated. If no more sections are present in the selected resource, at a further step 670 the resource header is created, and the resource is created by concatenating the resource header and the one or more sections, with the result stored in persistent storage. At a further step 680, if no more PageResource or DataResource object instances remain to be processed, the process terminates. If at least one more PageResource or DataResource object instance remains to be processed, at a further step 690 the next PageResource or DataResource object instance is selected, and step 620 is repeated.

Once all PageResource and DataResource object instances in the in-memory object representation have been processed by the steps of flow chart 600, the binary contents of all Resource object instances are stored as image or font resources to complete the modified executable application.

To further elucidate the steps of FIG. 2, attention is now directed to FIG.7, which depicts a schematic view of a user interface (UI) 700 of an exemplary computer application configured to perform the steps of flowchart 200. In particular, the interface is configured to perform steps 220, 225, 230 to annotate the in-memory object representation of the executable application, and to perform steps 245, 250, 255 to modify the in-memory object representation of the executable application. User interface 700 comprises a set of panels 710, 720, 730, 740, 750 that display various attributes of the application. In an exemplary application, the attributes of the application that may be selected for annotation include object instance, property, variable, style and substyle names, and the attributes of the application that may selected for modification include the values of object instance properties, variables, and style and substyle structure properties. Accordingly, a panel 710 depicts the object instance hierarchy using a tree display commonly employed in the art. Any object instance that has child objects is shown with an icon (depicted in this schematic view by [−] and [+]) that allows the tree display to be compressed or expanded at a user's choice, following conventional UI practice. Each object instance in the hierarchy also has an icon signifying the type of object (depicted in this schematic view by (P), (T), and (I)), and a name. A user can select an object instance in the hierarchy by moving the cursor over the object line and pressing the left mouse button. The selected object instance is highlighted, as depicted for the multiple-line text_{—}0_{—}1 object instance 711. A panel 720 displays the property names and values for the object instance selected in panel 710. A panel 730 displays variables defined in the page resource containing the page object instance that is currently selected or that contains the currently-selected object instance, and displays the values of the variables. A panel 740 displays the names and contents of all styles and substyles defined in the application in a collapsible tree view. A panel 750 displays the names of the image and font resources in the application; the name of a resource could be selected for annotation, and the content of a resource could be selected for modification.

As is known in the prior art, panels 710, 720, 730, 740, 750 preferentially include a vertical scrollbar control that is displayed when the contents to be displayed in a panel exceed the vertical space available in the panel. The vertical scrollbar may be manipulated through conventional interactions to move up and down in the visual display content of the panel. Panels 710, 720, 730, 740, 750 preferentially include a horizontal scrollbar control that is displayed when the contents of any single line in the panel exceed the horizontal width available in the panel. The horizontal scrollbar may be manipulated through conventional interactions to move left and right in the visual display content of the panel.

The UI 700 further comprises a panel 760 that depicts a simulation of the executable application, the execution of which can be controlled by a user through mouse selection of a run/pause icon 770 and a restart icon 780. If run/pause icon 770 is in the pause mode and a user moves the cursor over the run/pause icon 770 and presses the left mouse button, the application simulation will commence or continue. If run/pause icon 770 is in the run mode and a user moves the cursor over the run/pause icon 770 and presses the left mouse button, the application simulation will pause. If a user moves the cursor over restart icon 780 and presses the left mouse button, the application simulation will terminate and the simulation will be returned to the initial load condition.

When the application simulation is paused, if the object instance 711 that is selected in the widget display panel 710 has a visual representation on the simulation panel 750, the visual representation 761 of the selected object instance is highlighted. Further, in this exemplary implementation, when the application simulation 760 is paused, a user can select an object instance in widget display panel 710 by moving the cursor over a portion of the simulation panel 760 and pressing the left mouse button, thereby selecting the object instance if any that produces the portion of the visual representation on the simulation panel 760 under the position of the cursor.

With reference to the foregoing description of the exemplary UI 700, the author can perform steps 225 and 230 described above through use of the exemplary UI 700. For example, a user can select the name of an object instance for annotation by manipulating the display of the object instance tree in the object instance hierarchy panel 710 by clicking the collapse/expand icons and using vertical and/or horizontal scrollbar controls as required to display a desired object instance, then selecting the object instance to rename by moving the cursor over the entry for the object instance and pressing the left mouse button. Alternatively, a user can move the cursor over the simulation panel 750 when the simulation is paused and select the visual representation of an object instance as described above to select the object instance. A user can then move the cursor over the name of the object instance and double click the left mouse button to highlight the object instance name, thereby accomplishing step 225, and then type in an alternative name, thereby accomplishing step 230. Thus, for example, a user could use this technique to change the name of object instance 711 from “multiple-line text_{—}0_{—}1” to “slogan_widget”. As a further example, a user could select the name of a property of an object instance to annotate by selecting an object instance as described above; using the vertical scrollbar control of property panel 720 as required to display the desired property name; moving the cursor over the property name in property panel 720; and double clicking the left mouse button to highlight the property name, thereby accomplishing step 225. The user can then type in an alternative name, thereby accomplishing step 230. Thus, for example, the user could use this technique to change the name of object property 721 from “mtwValue” to “slogan-text”. As a still further example, a user can select the name of a variable instance for annotation by using the vertical scrollbar control of variables panel 730 as required to display the desired variable instance; moving the cursor over the variable instance in variables panel 730; and double clicking the left mouse button, thereby accomplishing step 225. A user can then type in an alternative name, thereby accomplishing step 230. As a still further example, a user can select the name of a style or substyle object instance for annotation by manipulating the display of the style instance tree in the styles panel 740 by clicking the collapse/expand icons and using the vertical and horizontal scrollbar controls as required to display the desired style or substyle object instance; moving the cursor over the style or substyle instance name; and double clicking the left mouse button, thereby accomplishing step 225. A user can then type in an alternative name, thereby accomplishing step 230. Similar steps could be performed to annotate the name of a resource in a resources panel (not shown).

With reference to the foregoing description of the exemplary UI 700, a user can further perform steps 240 and 245 described above through use of the exemplary UI 700. For example, a user can select the value of an object property for modification by using vertical scroll bar controls in properties panel 720 as required to display the desired object property; moving the cursor over the value portion of a property line in properties panel 720; and double clicking the left mouse button, thereby selecting the value to modify and accomplishing step 240. A user can then type in the new value for the property, thereby accomplishing step 245. If the property value to be modified is a resource, then a file selection dialog would be presented to allow a user to select alternative content for the resource. Similar actions can be used to modify the values of variables or attributes of styles or substyles through selecting items in variables panel 730 or styles panel 740 respectively. Modification of resource content can be performed by selecting a specific resource in a resource panel 750, then using a file selection dialog to select alternative content for the resource.

The foregoing descriptions of user interactions with the schematic UI are intended to be representative and are not intended to be limiting on the scope of the inventive method. Other conventional UI presentation and interaction techniques may also be used to accomplish these and other tasks without departing from the scope and spirit of the inventive method.

The term “computer” is used herein to refer to any device with processing capability such that it can execute instructions. Those skilled in the art will realize that such processing capabilities are incorporated into many different devices and therefore the term “computer” includes PCs, servers, mobile telephone, personal digital assistants and many other devices.

The methods described herein may be performed by software in machine readable form on a storage medium. The software can be suitable for execution on a parallel processor or a serial processor such that the method steps may be carried out in any suitable order, or simultaneously.

The description acknowledges that software can be a valuable, separately tradable commodity. The description is intended to encompass software, which runs on or controls ‘dumb’ or standard hardware, to carry out the desired functions. It is also intended to encompass software which ‘describes’ or defines the configuration of hardware, such as HDL (hardware description language) software, as is used for designing silicon chips, or for configuring universal programmable chips, to carry out desired functions.

The steps of the methods described herein may be carried out in any suitable order, or simultaneously where appropriate. Aspects of any of the examples described above may be combined with aspects of any of the other examples described to form further examples without losing the effect sought.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. In a computer system providing an application authoring environment, a method of creating a modified version of an executable application characterized by:
processing an executable application to create an in-memory object representation of said application;
selecting at least one attribute of said in-memory object representation for modification;
modifying said at least one attribute of said in-memory object representation; and
generating an executable application from said modified in-memory object representation.

2. The method of claim 1, further characterized by:
storing said in-memory object representation into persistent storage; and
retrieving said in-memory object representation from persistent storage.

3. The method of claim 2, wherein the storing step includes serializing the object hierarchy into an Extended Markup Language (XML) file in persistent storage.

4. The method of claim 3, wherein the retrieving step includes de-serializing the XML file into an object hierarchy to re-create the in-memory object representation.

5. The method of claim 1, further characterized by:
annotating at least one attribute of said in-memory object representation with at least one human-readable tag; and
using said at least one human-readable tag when selecting said at least one attribute of said in-memory object representation for modification;

6. The method of claim 5, further characterized by:
storing said in-memory object representation and said at least one human-readable tag into persistent storage; and
retrieving said in-memory object representation and said at least one human-readable tag from persistent storage.

7. The method of claim 1, where selecting said at least one attribute for modification is performed in part by interaction with a simulation of said executable application.

8. The method of claim 1, where said attribute of said in-memory object representation to be modified is one of the position, size, shape, or color of a region of color displayed by said application; one of the position, background color, font face, font size, font weight, text color, alignment, or textual content of an area of text displayed by said application; or one of the position, size, or image content of an image displayed by said application.

9. The method of claim 1, wherein the in-memory object representation of the executable application includes a set of object instances that form an object hierarchy.

10. The method of claim 1, wherein the executable application is an ETV-BIF executable application, the method further including:
allowing selection of a first PageResource object instance of the ETV-BIF executable application, said first PageResource object having a heap with structures associated therewith;
if the first PageResource is selected, allowing determination of a size and a sequential order of heap structures of the PageResource object; and
computing all absolute and relative heap offsets contained in the heap structures and storing said offsets into respective heap structures.

11. In a computer system configured to create a modified version of an executable application, including:
a processor configured to create an in-memory object representation from an executable application;
a graphical user interface configured to allow selection of at least one attribute of said in-memory object representation for modification;
means for modifying said at least one attribute of said in-memory object representation; and
a program configured to generate an executable application from said modified in-memory object representation.

12. The computer system of claim 11, wherein said graphical user interface includes a plurality of panels displayed on a display, with each panel displaying various attributes of the executable application.

13. The computer system of claim 12, said graphical user interface further including at least one panel displaying an object instance hierarchy of the in-memory object representation, wherein each object of the instance hierarchy may be selected by a user of the computer system.
